(19) United States
(12) Patent Application Publication
(10) Pub. No.: US 2014/0006286 A1
(43) Pub. Date: Jan. 2, 2014

(54) PROCESS TO INITIATE PAYMENT

(71) Applicants: Mark Gerban, Hamburg (DE); Tim Harder, Hamburg (DE)

(72) Inventors: Mark Gerban, Hamburg (DE); Tim Harder, Hamburg (DE)

(21) Appl. No.: 13/928,704

(22) Filed: Jun. 27, 2013

(30) Foreign Application Priority Data
Jul. 2, 2012 (DE) 10 2012 013 054.6
Mar. 15, 2013 (DE) 10 2013 004 413.8

(51) Int. Cl. G06Q 20/40

(52) U.S. Cl. CPC G06Q 20/40145
USPC 705/44

(57) ABSTRACT

A method to initiate payment is provided. The method includes registering a seller with a service provider, registering a customer with the service provider, starting a payment process, reading a biometric identifier of a customer and transmitting the biometric identifier to the service provider, comparing the read biometric identifier with stored biometric data to generate a comparison result and initiating payment with the comparison result and with other stored data.

This application claims priority under 35 U.S.C. §119(a) to German Patent Application No. 10 2013 004 413.8 filed on Mar. 15, 2013, which claims priority to German Patent Application No. 10 2012 013 054.6, filed on Jul. 2, 2012, the disclosures of which are incorporated herein by reference in their entireties.

### BACKGROUND OF THE INVENTION

1. Field of Invention

This invention relates to a process to initiate a payment.

2. Description of Related Art

In the modern world, many processes and interactions of human beings depend on electronic systems which, in comparison to the respective classical methods, have certain advantages, but also have disadvantages and risks. For example keys for access to buildings or certain sections of buildings are being increasingly replaced by access cards or codes that are electronically readable.

In many cases, cashless payment methods such as credit or bank cards (electronic cash/EC card) issued by credit institutions are used to make payments. Usually, a personal identification number (PIN) or a signature is required to use these cards for payment. Some credit cards also have a picture of the owner printed onto them. On the one hand, this simplifies the payment process; on the other hand, the danger of misuse must be taken into account. For example, a check on fraud may be realized by checking back upon user data. While initiating the authorization of the payment process, the card used for the payment, serves to provide information (e.g. credit institution, account number and identification data). The user also must authenticate himself which means he has to prove that he is the rightful user of the card used, in order to authorize the payment.

Literature in the art describes payment systems utilizing personal data. In this context, authorization generally refers to the process in which a credit institution permits payment via, e.g., EC (Debit Cards) or credit card. In general, this means an analysis of the data on the card, and possibly a personal identification number. Authorization is in most cases performed on-line and tells the seller that by this specific transaction, the customer's account will be debited with the authorized amount.

U.S. Patent Application Pub. No. 2004/0098336 describes a link between several payment terminals and credit institutions where every terminal is assigned to an account. These terminals read the credit card number and a fingerprint impression of the credit card user and trigger the payment after this data has been matched with the account data at the respective credit institution. Disadvantages of such a system are that direct connections between terminals and credit institutions must be established and that customers have to carry their credit cards.

In U.S. Patent Application Pub. No. 2007/0005988, the security level of a general authentication is raised using more personal data, e.g., fingerprint, face recognition, signature etc., which is read by registration units and processed by an authentication unit.

U.S. Patent Application Pub. No. 2009/0177586 presents a system for cashless payments with one payment device and one authentication device. The payment device can read a credit card. The authentication device reads a fingerprint of the credit card user and matches it with a reference fingerprint that is either on the credit card itself or in an external database communicating with the payment device. Disadvantages are that the credit card must still be carried and that the matching of the authentication data happens via the device in the actual place of payment which requires a certain computing power.

U.S. Patent Application Pub. No. 2012/0132706 A1 describes a process in several stages. Here, the credit card user and the seller both have their own device: a smartphone or a barcode scanner. Using separate communication channels, user and seller are connected for this payment transaction at one credit institution. The account is verified using a code that the credit institution sends to the seller. Then the seller uses his device to read a biometric identifier of the user, and sends this to the credit institution for authentication. This means it is a complex and time-consuming process during which the participants must exchange data with each other and also with a credit institution.

DE 10 2006 044 135 A1 explains how a service of a communication end device can be protected with a fingerprint.

All references cited herein are incorporated herein by reference in their entireties.

### BRIEF SUMMARY OF THE INVENTION

Accordingly, there is provided a process to initiate a payment. The invention includes a payment process that is characterized by simplicity and is very user-friendly. In accordance with the present invention, at least one seller is registered with a service provider. At least one customer is registered with the service provider. A payment process is started, wherein one biometric identifier of the customer is read and transmitted to the service provider. The service provider compares the read biometric identifier with stored biometric data and creates a comparison result. Payment is then initiated at least with the comparison result and with other stored data.

### BRIEF DESCRIPTION OF SEVERAL VIEWS OF THE DRAWINGS

The invention will be described in conjunction with the following drawings in which like reference numerals designate like elements and wherein:

FIG. 1 is a schematic drawing of one application of the authorization system;

FIG. 2 illustrates an example sequence of procedural steps of the inventive method; and

FIG. 3 illustrates an example order of the persons participating in a payment transaction according to the inventive method.

### DETAILED DESCRIPTION OF THE INVENTION

The invention strives to specify a process to initiate payment that is characterized by simplicity and is very user-friendly.

The invention generally involves a procedure to authorize a person for a transaction. The transaction to be authorized can, for example, be a part of a payment process or, e.g., granting access to a certain area, opening a safe, deactivating an alarm system, etc.

A person can be authorized for a transaction via at least the following steps: initiation of the authorization using at least one reading device to read at least one biometric identifier of the person; comparison of the at least one biometric identifier with stored biometric identifiers through a comparison device, based on this comparison and the stored biometric identifiers generating at least one comparison result for the authorization of the person; and transfer of the at least one comparison result to at least one receiving device by the comparison device.

The process preferably includes reading at least one biometric identifier via at least one reading device to initiate authorization. This biometric identifier can be, for example, a fingerprint, an image of the face, an image of the iris, words spoken by the person or a signature. Generally it should be an identifier that the person carries through and within himself. Prior art initiates such an authorization generally through a scan of a credit card, bank card, access card or other entitlement card.

The inventive process described herein uses a biometric identifier. As a person inevitably always has his biometric identifiers with him, this process is simpler and more user-friendly than other systems, preferably rendering cards described in the prior art no longer necessary (except, e.g., in the case of a hybrid unit, described below). One embodiment of the present invention requires only one biometric identifier. Other embodiments of the present invention may require several biometric identifiers to initiate, i.e., begin the authorization.

In one embodiment, the reading device uses the recording features of, e.g., a smartphone, a mobile phone, a tablet PC, etc., which often have built-in cameras and microphones. An alternative embodiment uses a separate device, e.g., to perform data processing or data preparation internally or to improve the recording quality. This separate device can be connected to one of the means of communication mentioned above or a computer. An alternative embodiment includes a separate reading device which is able to read a biometric identifier (e.g., fingerprint, image of the face or the iris, etc.) as well as a credit card, bank card or any other card for authorization. This kind of reading device could be referred to as a hybrid unit. The option of reading a card serves in particular to register the person with the provider of the authorizing procedure, if this procedure is to be used. Alternatively, the hybrid unit can be used for “classical” payments via credit card. Therefore, such hybrid units allow a process to initiate a payment in the way of the invention as well as the classical way. The payment method can also include other established processes like PayPal or Amazon. A web application integrates this method so that the options of these providers can also be used.

Then at least one biometric identifier of the person is then in one embodiment transferred via at least one transmission device, to at least one comparison device. In one embodiment, the transmission device is a so-called smartphone with a connected reading device serving as a sort of scanner. In one embodiment, the smartphone or a program on the smartphone controls the reading device and taps the read data in order to communicate them to a comparison device. In general, a smartphone in this context is a mobile phone with more functionalities than a basic mobile phone. As an alternative to the smartphone, another embodiment uses a so-called tablet computer/tablet PC. In general, mobile units that can establish an Internet connection are preferred. For example, a laptop or notebook could also be used for the transmission of the read data.

Especially in one embodiment, a direct data connection with the comparison device is established to transmit the at least one scanned identifier of the person. In one embodiment, a data processing unit, for example accessible via a website, forms the comparison device which is preferably contacted directly and therefore without another data processing unit. Thus, in this embodiment, communication via a data format like SMS or through a transfer via connection with a phone or network provider is omitted.

The comparison device has biometric identifiers on file and in particular links them with the relevant user and access data. These access data contain in particular the data that are needed for the respective authorization. If the authorization serves to initiate a payment process, the biometric data are in particular, linked to the respective account data. In one configuration, the account data relevant to the payment refer in particular to so-called cyber wallets/e-wallets and/or different varieties of so-called pre-paid cards, to online banking possibilities, to payment via landline or mobile numbers, to direct debiting via bank accounts, etc. Generally, the stored biometric identifiers are put together with the data relevant to an effective implementation of the payment. This can happen via the provider's website which processes the authorization and preferably also handles the rest of the transaction, in this case the payment, in combination with the stored data. Another configuration therefore provides that, during or after the authorization, the person has to choose the account or the payment method he wants to use.

If it refers to opening a door, access rights are assigned. The comparison device then compares the at least one read biometric identifier of the person with the stored biometric identifiers and creates a corresponding comparison result from those sets. If no matching biometric identifiers are found, the comparison result might be refusal of the authorization. If matching stored biometric identifiers are found, preferably matching the read biometric identifiers within a set tolerance range, the comparison result is generated depending on the relevant data. Those might include the credit line. Alternatively, it can mean an acknowledgment of the payment, etc. To find the stored biometric data, it is preferable that the person has registered beforehand with a provider of this means of authorization, and therefore has had their biometric identifiers read and stored in a way that the comparison device can access them.

Subsequently, then at least one comparison result is transferred to at least one receiving device. In one configuration, transfer and receiving device are combined in the form of a smartphone, which then receives the comparison result after the final step. Depending on the configuration, further steps are initiated based upon this, e.g., entering further biometric identifiers or some sort of acknowledgment by the person. Alternatively, while initiating the authorization, finding a respective data set can initiate the transaction itself at the same time. If the transaction is a payment process, the initiation can happen when a fingerprint and/or an image of the face (keyword: face recognition) of the person is read and transmitted to the comparison unit. At the same time, the amount to be paid is calculated via a register scanner and also transmitted to the comparison unit or a unit connected to it. If the comparison unit finds the data set matching the person and if the stored data allow it, in this example the payment is triggered immediately, meaning that the comparison result in this case is the transmission of the notification “payment is being effected” to the receiving device. In particular, this can also happen without a so-called APP (application). The result—as well as the functionalities for customers/buyers or sellers/merchants—is shown via a web application on a website. Display and interaction with the user are preferably within a web browser, alternatively they can also be within an app or only in the browser on a web server of the service provider that enables authorization or payment. In one embodiment, further processing of the data or the transaction etc. is preferably done by the provider of the authorizing procedure.

In one embodiment, the authorization of the transaction is initiated by reading only one or only biometric identifiers of the person. In another embodiment, other entries are also used in a further stage of the transaction. To initiate the authorization, however, preferably only biometric identifiers are used. In particular, credit cards are preferably not used. In an alternative embodiment, only data that the person can enter themselves, e.g. an access code or further biometric identifiers, are used to continue the respective transaction, e.g., to initiate further steps or sequences. For additional security, where applicable, several biometric identifiers are read or a PIN is entered supplementary.

In case of an implementation that requires a smartphone as an element for at least one procedural step, in particular in one embodiment, at least one program compatible with the smartphone is started before then, at least one biometric identifier of the person is read.

Another embodiment of a process to initiate payment comprises the following steps: at least one seller is registered with a service provider; at least one customer is registered with the service provider; a payment process is started; one biometric identifier of the customer is read and transmitted to the service provider; the service provider compares the read biometric identifier with stored biometric data and creates a comparison result; and, at least with the comparison result and with other stored data, the payment is initiated.

Hence, the process includes the seller's and the customer's registration. Both register with a service provider which in particular provides a web application and a website. Upon purchase, one biometric identifier of the customer/buyer is read and transmitted to the web application. In order to do that, a terminal in particular must have an application/a program that, for example, via a sensor, is able to read the fingerprint and transmits it to the website. The web application compares the read biometric identifier with the stored data and preferably finds the data set related to the customer. If the customer is registered and solvent, the payment can be initiated via the service provider. The data is stored, for example, on the data server or, if applicable, locally with the seller. The registration of the seller can be done via any Internet connection, whereas the registration of the buyer is connected to an application that can read the relevant biometric identifier.

In one embodiment, a fingerprint of the customer is read as biometric identifier. In another aspect, the seller is registered with the service provider as follows: a program is started on a terminal; this program opens a web application; data is entered into this web application; and an ID identifier is created for the program and the seller. Alternatively, the seller can be registered if they starts a web application directly in any browser and, if applicable, logs into the program separately with a terminal they uses.

In one embodiment, the customer is registered with the service provider as follows: a program is started on a terminal; a reading device, e.g., a sensor or a camera, reads the biometric identifier of the customer; the program opens a web application; the program transmits the read biometric identifier to the web application; data is entered into this web application; and this data is assigned to the read biometric identifier.

To avoid ambiguities with similar fingerprints or for additional security, one embodiment provides that the customer enters a code for a PIN stored with the service provider, once the payment process has started, and that the service provider compares the entered code with the stored data and creates a comparison result based on it.

In one embodiment, the ID identifier of the seller is transmitted to the service provider, if payment is initiated by the read biometric identifier.

In one embodiment, the payment process begins when the seller starts a program on a terminal and enters the amount payable by the customer.

In one embodiment, the service provider provides a web application for the seller and the customer and the procedural steps are done via the web application.

In one embodiment, the registration of the seller and the customer as well as initiation of the payment or finding the matching data set for the customer are effected in one combined web application. Furthermore, in one embodiment, an application is started on a terminal to initiate the registrations or the payment.

Hereafter, exemplary implementations are described to clarify the process according to the invention. But it should be understood that the present invention is not deemed to be limited to these exemplary implementations.

The relevant transaction may, e.g., involve the payment for an article.

As used herein, the term “web server” generally refers to a server that can host web applications. Access to these applications is granted over the Internet. Communication from server to server (without a browser) and from client to server (via browser, no matter if on a PC, tablet PC or mobile phone) is possible. The usage of a database is optionally included.

As used herein, the term “web application” generally refers to an application that can be operated on a web server. All technologies such as PHP, JAVA, RubyOnRails or HTML5 and Flash in connection with JavaScript and APIs like PhoneGab, Calatrava or JQuery and others, may be used to build such a web application.

As used herein, the term “application” or “app” generally refers to an application that communicates with the web application, and is generally to be understood as any mode of control for a process or a device or a terminal. It is insignificant if the application is operated on a device and controls it or if it uses another device to do so. An app can be realized with any suitable and necessary technology for a terminal. For example, the basic technology for an Android smartphone would be the language JAVA. Implementation, communication and formatting can be realized with any suitable technology and any suitable protocol. Most frequently used are, for example, HTTP/HTTPS requests on a basis of TCP/IP. Communication from server to server or from a client to a server, e.g., with a web browser as client, is in principle equivalent. The application can be operated on a mobile phone, a tablet PC or any other suitable device with an Internet connection (Wi-Fi, DSL, 3G and all other forms).

The application (app) may, in some embodiments, require a fingerprint sensor or a terminal. As used herein, a fingerprint “sensor” or “terminal” generally refers to something that can be integrated into a device or connected to the mobile phone/tablet PC via an interface. For example, Wi-Fi, NFC (Near Field Communication), USB, FireWire, infrared as well as any other mode of connection can be used. The read fingerprint is then made available to the application by the sensor; the application then transmits it to the web application. This can happen from a mobile phone, PC, tablet or any other suitable device, regardless of which operating system is used (UNIX, Linux, Windows, OS, iOS, Apple). Thus, to implement the invention for payment, an application on a terminal (e.g., mobile phone) and a unit to read a fingerprint is required.

In a first step of an embodiment of a method according to the present invention, a seller or merchant registers with a provider of the payment system, or with the provider of the authorization for the payment transaction. The service provider can thereby be an intermediary between the merchant and at least one bank or banks or other payment systems, such as PayPal.

The merchant starts an application (app), e.g. on his mobile phone or a tablet PC etc., which in turn starts a web browser and opens a website of the provider or a web application. The seller enters his relevant data (name, address, bank details, etc.) on this website or via the web application of the provider. The website generates a special ID identifier for the used application and the seller to identify him. This ID identifier is independent of the utilized terminal and unique for the merchant. The ID is transmitted to the application that saves it locally.

Accordingly, in one embodiment of the present invention, an aspect of the process is as follows: 1. Starting the application (app); 2. The app opens a website; 3. The merchant enters the relevant data on the website; 4. The website generates an identifier (ID); 5. The ID is transmitted to the application; and 6. The app saves the ID.

The advantage of a registration via the website is that the application is independent of the operating system and of the hardware/terminal used to start the application (app).

After the merchant has registered with the service provider, he is able to enable payment via the service provider for his customers.

Furthermore, the buyer also registers with the service provider. He also starts the application (app).

The buyer registers—after having started the application—by letting the application read a biometric identifier, e.g., a fingerprint. A reading device, e.g., a camera or an attachment in general as a sensor on a mobile phone or a tablet, is planned as a terminal.

The application opens the web application of the service provider for the buyer's registration and transmits the fingerprint it received from the sensor via an API to the web application. After opening the web browser, the application only transmits the fingerprint to the web application.

The website saves the fingerprint—temporarily at first—and the buyer enters his relevant data (e.g., name, address, bank details, etc.) via a web application, for example in a local database. In case of an interruption of the registration process, the fingerprint on the website is deleted. The data can be transmitted, for example, to the web application via HTTP Post. Here, as it is known from submit form actions, information is transferred to the web application in such a way that it can access it directly. For example, a fingerprint is encoded (and encrypted) in binary form and then has a form “100101”; the web application can then receive this value to compare it, for example, with the fingerprint saved in the database. The buyer does not need an ID for the buying process because the entered PIN (to be chosen or, if applicable, predefined by the bank or the service provider) and the fingerprint form a unique identifier and no other parameter is needed to identify the buyer. Once the buyer has entered his data, he finishes his registration.

It is essential for the database or the web application that the data of the buyers can be found in each case via their fingerprints. This is contrary to prior art which uses a PIN or an account number to access the registered data. A PIN can be planned for additional security or to distinguish between registrations of customers with similar fingerprints.

Accordingly, in one embodiment of the present invention, an aspect of the buyer's registration process is as follows: 1. The application (app) is started, e.g., on a mobile phone; 2. A sensor reads a fingerprint; 3. The application opens a website; 4. The fingerprint is read from the sensor via an API and is transmitted to the website via the app; 5. The relevant data of the buyer—as well as the PIN—are entered via the website of the service provider; 6. The relevant data is stored in a way that it can be accessed via the fingerprint; and, 7. The buyer's registration is finished.

If a registered buyer wants to make a purchase from a registered seller/merchant, the seller starts the application on his terminal. Any Internet connection can be used for the registration. The app just has to be at least installed on the terminal afterwards.

The seller opens the application on his mobile phone/PC or tablet and then enters the amount to be paid for the goods by the customer on the corresponding website. This can either be done directly (standard procedure) or via a connection between, e.g., a cash register (or other checkout station) and the application. After that, the seller hands the mobile phone to the buyer and asks for his fingerprint. The application transmits the fingerprint it received via the API from the fingerprint sensor to the web application. Based on the fingerprint, the web application searches for the respective customer account and displays the relevant user data in the web browser. In further steps, a PIN can be entered as well. Further connections or displays are made via the website. For payment, either a bank is contacted directly and instructed to make the payment or the pending transactions are saved by the service provider and the money transfer is initiated at a later time. Also, accounts from other providers can be integrated. These actions depend on the data the buyer has left during his registration.

In one embodiment, the actual payment uses the following procedure: 1. The seller starts the application on his mobile phone/tablet computer, thereby transmitting the merchant's ID; 2. The seller enters the amount payable; 3. The mobile phone is handed to the buyer; 4. The fingerprint of the buyer is read; 5. The fingerprint is transmitted to the web application; 6. The registration account of the buyer is found in the database for the web application via the fingerprint; 7. If applicable, a PIN is entered or optionally the buyer is asked for confirmation; 8. The data of buyer and seller are transmitted to the actual bank or another payment service Provider—if applicable, in connection with the functionalities, etc.; and, 9. The seller receives a confirmation that the payment has been initiated.

One advantage is that the seller can start the payment with only one application on one device and all other actions are executed via a website. Therefore, it is not bound to hardware and is also independent of any operating system used (provided that the app can be operated on different operating systems or mobile phones). The different operating systems require different apps. The actual service—the payment process and the administration of the registration data—is offered via the website of the web application and is therefore not part of the application. Furthermore, the buyer's account is only accessible via the fingerprint, if applicable, when the buyer also enters the necessary PIN.

The application—for example—on the mobile phone serves to establish a connection with the web application. Furthermore, the application reads the data from the fingerprint sensor via the API, combines the read fingerprint with the merchant's ID and transmits the fingerprint and the ID to said web application. For the data transmission, if applicable, a suitable encryption is provided.

The web application is, for example, activated by a normal web request HTTP/HTTPS, while the fingerprint with the ID identifier is transmitted as a parameter in this request. The mode of encryption, the used format etc., are freely selectable and are also controlled by the web application. All interactive functions for the users (merchants or buyers) are available in the web application in the browser and not in the app on the terminal/mobile phone/PC etc.

This results in the advantage of cross-platform applications that allow the application on virtually every terminal, independent of its operating system.

Furthermore, the invention also contemplates a system where the process is implemented according to the invention. Here, at least the following components are contemplated: at least one reading device to read at least one biometric identifier; at least one comparison device to compare the at least one biometric identifier with stored biometric identifiers and to create at least one comparison result relevant for the authorization or payment, based on at least the comparison and on data assigned to the stored biometric identifiers; and at least one receiving device to receive the comparison result. The provisions made above about the process apply accordingly also to the system. In one embodiment of the system, at least one transmission device is provided to transmit the at least one read biometric identifier of the person to the comparison device in the system. In one embodiment it is contemplated in particular that the system has to be configured in such a way that it serves to implement the process in at least one of the process embodiments mentioned above.

In addition, the invention may comprise a machine-readable program which serves to implement the process and is saved on a machine-readable medium.

In detail, there are several possibilities to configure and further develop the process and the system according to the invention. Therefore, reference is made to the following description of implementation examples in connection with the drawing figures accompanying this specification.

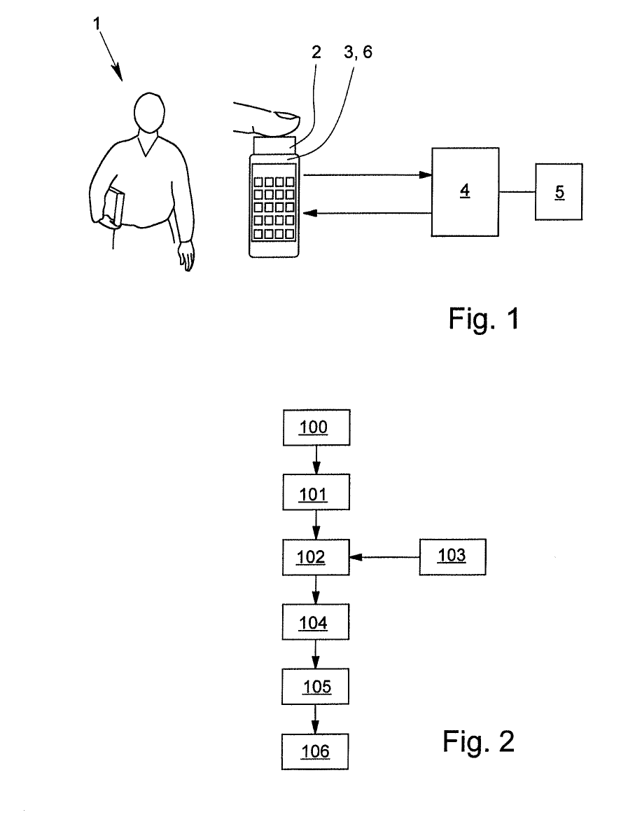

Referring now to FIG. 1, there are shown components that serve to authorize person 1 for a transaction. The example shown is a payment process that person 1 would like to initiate.

For example, to buy something in a shop, person 1 chooses the desired articles (e.g., a book) and asks at the cash register or checkout station that the payment for his purchase be executed via the process according to the invention, meaning that a cashless payment using his stored bank details is authorized and processed based on that.

In order to do so, the seller may use a smartphone, which serves in particular to control the reading device 2, but at the same time as transmission device 3 and receiving device 6. To authorize the payment of the purchase person 1 wishes to make, the reading device reads a fingerprint of person 1 as a biometric identifier and thus, initiates the authorization. Presentation of a bank or credit card or entry of a personal identification number (PIN) is preferably not necessary. In the embodiment shown, the reading device 2 is a separate unit. However, with modern mobile means of communication like smartphones, tablet PCs, etc., the mostly integrated optical unit in form of a camera/reader can be used to read biometric identifiers (fingerprint, image of the face, of the iris, etc.). As mostly such means of communication also have integrated microphones—especially for telephone purposes—one configuration can use the voice of the person as a biometric identifier.

At least the one read biometric identifier—in this case the fingerprint—is then transmitted by the smartphone as transmission device 3 to the comparison device 4. In particular, a direct connection between the transmission device 3 and the comparison device 4 is established so that in particular there is no data processing or data conversion by a unit, e.g., the network provider. The comparison device 4 can, for example, be a data server of a provider which offers the authorization system and preferably also to handle the rest of the transaction connected to the authorization (e.g., processing the payment with the respective credit institution).

In this case, the comparison device 4 has access to a data storage 5 where biometric identifiers and other related data of persons are stored who have registered for this way of authorization. The comparison device 4 compares the received data of the read biometric identifier and the stored biometric identifiers, and identifies the related data account if available. Based on this, the comparison device 4 transmits a matching comparison result to a receiving device 6 which is in this case identical to the transmission device 3 and in particular a smartphone. In one configuration, the comparison result can be only that person 1 is identified and that in a second step the payment is initiated or that the acceptance of the payment is acknowledged to the seller immediately upon matching data.

This makes the process very simple: A biometric identifier of the customer is read; A comparison unit 4 searches and, if applicable, finds the related data account; In a positive case, the person is registered and the data matches, and thus the authorization is completed.

In FIG. 2 the relevant procedural steps for an authorization of a transaction is shown with the example of a cashless payment. In the first step 100 a person registers with the provider of the authorizing procedure by entering their personal data, like name, address, bank or credit card details and one biometric identifier. The biometric identifier enables the authorization system to identify the person and further to access his data via the identifier. In step 101, the person makes a purchase and asks in step 102 the seller for a cashless payment via the authorization system. Prior to step 102, the seller as a party involved to use the authorization has taken step 103, where he registered with the provider as seller and in particular stored his own data to process cashless business transactions. For the process, the seller in particular downloads a so-called app (application) onto his smartphone which then performs the relevant processes automatically.

In step 104, the seller reads, for example, with an attachment to his smartphone as reading device 2, the biometric identifier of person 1, e.g., the fingerprint, and enters the amount payable. In step 105 the smartphone communicates with the comparison device 4 of the provider of the authorizing procedure. If the person is registered with his data and his biometric identifier, the comparison device 4 finds the related data set and in this case initiates the payment, if person 1 is authorized. Also, in step 106 the seller gets feedback in the form of a comparison result that, if applicable, announces that the payment was made or, in a negative case, that payment is not possible.

The payment is thus executed preferably without the customer having to carry a credit card or to remember a PIN or something similar. The advantage for the seller is that the communication happens directly with the service provider, that he can accept a correspondingly large number of bank and credit cards for payment because the service provider allows the communication, and that the implementation via smartphone makes him more flexible and he can use more flexible technology.

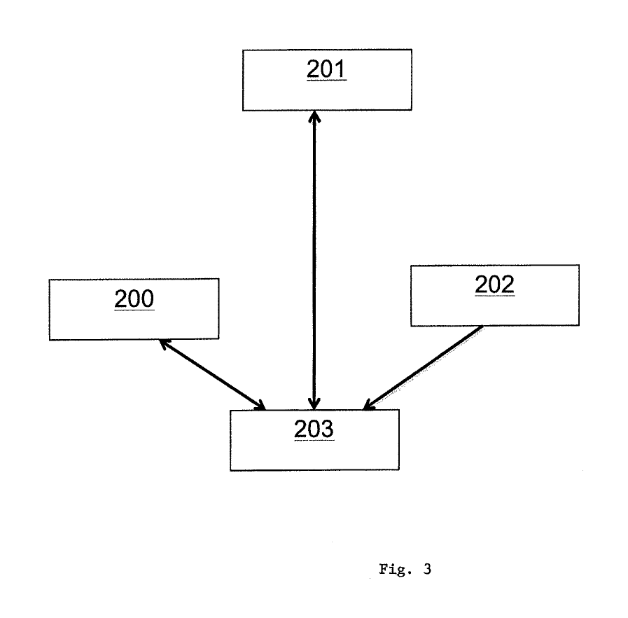

FIG. 3 shows a configuration between a seller 200 and a customer 202, who are connected by the service provider 201 via his web application 203 that enables the payment. The seller registers with the service provider 201 via his web application 203 and receives an ID identifier from the web application 203. The buyer 202 registers as well (however, the buyer 202 does not receive an ID, which is why the arrow only goes in one direction). The service provider 201 operates the web application 203 and the necessary components.

In case of a purchase, the seller 200 accesses the web application 203 and enters the amount payable. The buyer 202 lets his fingerprint be read, which is then—together with the ID identifier of the seller—transmitted to the web application 203. The web application 203 compares the read fingerprint with the stored data, if applicable, demands a PIN of customer 202, and, in a positive case, initiates payment. The payment here is a special case of the aforementioned authorization of a transaction. In order to read the fingerprint, a configuration like the one in FIG. 1 is used.

While the invention has been described in detail and with reference to specific examples thereof, it will be apparent to one skilled in the art that various changes and modifications can be made therein without departing from the spirit and scope thereof.

What is claimed is:

1. A method to initiate payment, comprising the steps of:
a. registering at least one seller with a service provider;
b. registering at least one customer with the service provider;
c. starting a payment process;
d. reading a biometric identifier associated with the customer and transmitting the biometric identifier to the service provider;
e. comparing the read biometric identifier with stored biometric data to generate a comparison result; and
f. initiating payment with the comparison result and with other stored data.

2. The method of claim 1, wherein the biometric identifier is a fingerprint.

3. The method of claim 1, wherein the registering of the at least one seller with the service provider comprises the steps of:
a. starting a program on a terminal, which program opens a web application;
b. entering data into the web application; and
c. creating an ID identifier for the program and the seller.

4. The method of claim 1, wherein the registering of the at least one customer with the services provider comprises the steps of:
a. starting a program on a terminal;
b. reading, using a reading device, the biometric identifier;
c. opening of a web application with the program, which program transmits the read biometric identifier to the web application;
d. entering data into the web application; and
e. assigning the data to the read biometric identifier.

5. The method of claim 3, wherein the registering of the at least one customer with the services provider comprises the steps of:
a. starting a program on a terminal;
b. reading, using a reading device, the biometric identifier;
c. opening of a web application with the program, which program transmits the read biometric identifier to the web application;
d. entering data into the web application; and
e. assigning the data to the read biometric identifier.

6. The method of claim 1, wherein the customer enters a code for a PIN stored with the service provider once the payment process has started and the service provider compares the entered code with the stored data, thereby creating the comparison result.

7. The method of claim 3, wherein the customer enters a code for a PIN stored with the service provider once the payment process has started and the service provider compares the entered code with the stored data, thereby creating the comparison result.

8. The method of claim 4, wherein the customer enters a code for a PIN stored with the service provider once the payment process has started and the service provider compares the entered code with the stored data, thereby creating the comparison result.

9. The method of claim 5, wherein the customer enters a code for a PIN stored with the service provider once the payment process has started and the service provider compares the entered code with the stored data, thereby creating the comparison result.

10. The method of claim 1, wherein during payment, an ID identifier of the seller is transmitted to the service provider.

11. The method of claim 3, wherein during payment, the ID identifier of the seller is transmitted to the service provider

12. The method of claim 1, wherein the payment process begins when the seller starts a program on a terminal and enters the amount payable by the customer.

13. The method of claim 3, wherein the payment process begins when the seller starts a program on a terminal and enters the amount payable by the customer.

14. The method of claim 1, wherein the service provider provides a web application for the seller and the customer and the procedural steps are done via the web application.

15. The method of claim 3, wherein the service provider provides a web application for the seller and the customer and the procedural steps are done via the web application.
